(19) United States
(12) Patent Application Publication
(10) Pub. No.: US 2026/0088999 A1
(43) Pub. Date: Mar. 26, 2026

(54) SYSTEM FOR PROVIDING BLOCKCHAIN-BASED MYDATA CARD

(71) Applicant: ICNCAST CO., LTD., Seoul (KR)

(72) Inventor: Bonggyeol CHOI, Seoul (KR)

(21) Appl. No.: 18/891,246

(22) Filed: Sep. 20, 2024

(51) Int. Cl. H04L 9/32

(52) U.S. Cl. CPC H04L 9/32

(57) ABSTRACT

A system for providing a blockchain-based MyData card includes a MyData generation unit configured to receive user information including personal basic information and personal detailed information of a user from a user terminal, receive information use consent from the user terminal, and generate MyData by receiving the user’s information through an external API, a data encryption unit configured to decentralize and encrypt the MyData on blockchain, an electronic identification card management unit configured to issue an electronic identification card to the user terminal that proves to belong to an affiliated organization using a blockchain-based decentralized identifier by receiving consent from an affiliated organization terminal in response to a request from the user terminal, and manage the electronic identification card issued to the user terminal, and an information provision unit configured to decrypt and provide the encrypted MyData to a viewer terminal with consent of the user terminal in response to a request from the viewer terminal.

### BACKGROUND OF THE INVENTION

### FIELD OF THE INVENTION

The present invention relates to a system for providing a blockchain-based MyData card.

### DESCRIPTION OF THE RELATED ART

South Korea is actively pursuing the establishment of various legislative systems to promote the data economy through the collection, production, trade, and use of data. The foundation for the domestic MyData policy was laid through the amendment of the Three Data Laws in 2020 and the enactment of the Data Industry Act and the Industrial Digital Transformation Act in 2021 and 2022.

The MyData industry refers to a series of processes in which individuals actively manage and control their own information and actively use this information for credit, asset management, or the like.

Currently, MyData is decentralized across various companies and organizations in fields such as finance, healthcare, telecommunications, and distribution. When the corresponding data is made available based on the rights of the information subject, the MyData may be applied to any field where value can be created, thereby enabling financial consulting or analyzing consumption patterns based on the results of personal data analysis.

Meanwhile, a decentralized identifier (DID) is built on blockchain technology and may be used in an electronic identification card system. Specifically, just as an ID, such as a resident registration card, is taken from a wallet in the real world to prove identity, a decentralized identifier (DID) can be submitted from a blockchain wallet only in a situation where it is needed to prove identity. This has the characteristic of allowing individuals to have complete control over their own information during the identity verification process compared to conventional identity verification methods.

### SUMMARY OF THE INVENTION

The present invention is directed to providing a system for providing a blockchain-based MyData card, which is capable of receiving user information from a user terminal to generate MyData, encrypting the MyData on blockchain, in response to a request from a viewer terminal and with the consent of the user terminal, decrypting and providing the MyData to the viewer terminal, and issuing and managing an electronic identification card using a blockchain-based decentralized identifier for the user terminal.

According to an aspect of the present invention, there is provided a system for providing a blockchain-based MyData card. The system may include a MyData generation unit configured to receive user information including personal basic information and personal detailed information of a user from a user terminal, receive information use consent from the user terminal, and generate MyData by receiving the user’s information through an external API, a data encryption unit configured to decentralize and encrypt the MyData on blockchain, an electronic identification card management unit configured to issue an electronic identification card to the user terminal that proves to belong to an affiliated organization using a blockchain-based decentralized identifier by receiving consent from an affiliated organization terminal in response to a request from the user terminal, and manage the electronic identification card issued to the user terminal, and an information provision unit configured to decrypt and provide the encrypted MyData to a viewer terminal with consent of the user terminal in response to a request from the viewer terminal.

The MyData may include expert information including the user's career, specialty, degree, and research history, and the system for providing a blockchain-based MyData card may further include an expert matching unit configured to provide a list of recommended experts available for viewing in a descending order of similarity by comparing and analyzing the expert information selected by the viewer terminal for viewing information and the expert information input by the user terminal.

The expert matching unit may provide a list of additional experts including other users belonging to an affiliated organization of the user whose MyData is viewed on the basis of a history of viewing the MyData by the viewer terminal.

The system for providing a blockchain-based MyData card may further include a point profit unit configured to charge points to the viewer terminal that receives the MyData from the information provision unit.

The system for providing a blockchain-based MyData card may further include a reward provision unit configured to provide a reward to the user terminal of the user whose MyData is viewed, or to the affiliated organization terminal of an affiliated organization to which the user whose MyData is viewed belongs, when the viewer terminal views the MyData of the user.

The reward provision unit may differentially pay rewards to the affiliated organization terminal on the basis of the number of users belonging to the affiliated organization and a consent rate for viewing information of the users belonging to the affiliated organization.

The system for providing a blockchain-based MyData card may further include a security management unit configured to determine that hacking has occurred and deactivate the electronic identification card when a request for verification of the electronic identification card is received from a remote location within a predetermined period of time by receiving GPS information from the user terminal.

The security management unit may perform an additional personal authentication procedure from the user terminal to activate the electronic identification card upon completion of the personal authentication.

The security management unit may recall the MyData that has been viewed when viewing of the MyData of the user terminal is made within a predetermined period of time before or after an occasion when the user terminal is determined to have been hacked.

The system for providing a blockchain-based MyData card may further include a data processing unit configured to collect history data that the electronic identification card management unit has issued, verified, or managed the electronic identification card using blockchain, and analyze and process the history data and provide the history data to the user terminal or the affiliated organization terminal.

According to the present invention, the system is capable of receiving user information from a user terminal to generate MyData, encrypting the MyData on blockchain, in response to a request from a viewer terminal and with the consent of the user terminal, decrypting and providing the MyData to the viewer terminal, and issuing and managing an electronic identification card using a blockchain-based decentralized identifier for the user terminal.

### BRIEF DESCRIPTION OF THE DRAWINGS

FIG. 1 is a block diagram illustrating a system for providing a blockchain-based MyData card, according to an embodiment of the present invention.

FIG. 2 is a flow chart illustrating a method of issuing an electronic identification card and providing user information of a system for providing a blockchain-based MyData card, according to an embodiment of the present invention.

FIGS. 3 and 4 are flowcharts illustrating a method of verifying an electronic identification card and issuing an electronic identification card of a system for providing a blockchain-based MyData card, according to an embodiment of the present invention.

FIGS. 5 and 6 are flowcharts illustrating a method of providing a service of a system for providing a blockchain-based MyData card, according to an embodiment of the present invention.

FIG. 7 is a view illustrating a user information page of a system for providing a blockchain-based MyData card, according to an embodiment of the present invention.

FIG. 8 is a view illustrating an affiliated organization information page of a system for providing a blockchain-based MyData card, according to an embodiment of the present invention.

FIGS. 9 and 10 are views illustrating an electronic identification card of a system for providing a blockchain-based MyData card, according to an embodiment of the present invention.

FIG. 11 is a view illustrating a work process of a system for providing a blockchain-based MyData card, according to an embodiment of the present invention.

### DETAILED DESCRIPTION OF THE INVENTION

The present invention may be variously modified and may have various exemplary embodiments, and particular exemplary embodiments illustrated in the drawings will be described in detail below. However, the description of the exemplary embodiments is not intended to limit the present invention to the particular exemplary embodiments, but it should be understood that the present invention is to cover all modifications, equivalents and alternatives falling within the spirit and technical scope of the present invention. In the description of the present invention, the specific descriptions of publicly known related technologies will be omitted when it is determined that the specific descriptions may obscure the subject matter of the present invention.

The terms such as "first" and "second" may be used to describe various constituent elements, but the constituent elements should not be limited by the terms. These terms are used only to distinguish one constituent element from another constituent element.

The terminology used herein is used for the purpose of describing particular embodiments only and is not intended to limit the present invention. Singular expressions include plural expressions unless clearly described as different meanings in the context. The terms "comprises," "comprising," "includes," "including," "containing," "has," "having" or other variations thereof are inclusive and therefore specify the presence of stated features, integers, steps, operations, elements, and/or components, but do not preclude the presence or addition of one or more other features, integers, steps, operations, elements, components, and/or groups thereof.

In addition, in the contact relationship between respective constituent elements, the term "coupling" not only means physical and direct contact between the constituent elements but also be used as a concept including a case in which another constituent element is interposed between the respective constituent elements and in contact with the respective constituent elements.

Hereinafter, the embodiments according to a system 100 for providing a blockchain-based MyData card will be described in detail with reference to the accompanying drawings. In the description of the exemplary embodiments with reference to the accompanying drawings, the same or corresponding constituent elements are assigned with the same reference numerals regardless of reference numerals, and the repetitive description thereof will be omitted.

According to an embodiment of the present invention, there is provided a system 100 for providing a blockchain-based MyData card. The system 100 includes a MyData generation unit 110 that receives user information including personal basic information and personal detailed information of a user from a user terminal 10, receives information use consent from the user terminal 10, and generates MyData by receiving the user’s information through an external API 40, a data encryption unit 120 that decentralizes and encrypts the MyData on blockchain, an electronic identification card management unit 130 that issues an electronic identification card to the user terminal 10 that proves to belong to an affiliated organization using a blockchain-based decentralized identifier by receiving consent from an affiliated organization terminal 20 in response to a request from the user terminal 10, and manages the electronic identification card issued to the user terminal 10, and an information provision unit 140 that decrypts and provides the encrypted MyData to a viewer terminal 30 with consent of the user terminal 10 in response to a request from the viewer terminal 30.

According to the system 100 for providing a blockchain-based MyData card of the present embodiment, the system 100 may receive user information from the user terminal 10 to generate and encrypt MyData on blockchain, and decrypt and provide the MyData to the viewer terminal 30 by receiving consent from the user terminal 10 in response to a request from the viewer terminal 30. The system may issue an electronic identification card using a blockchain-based decentralized identifier to the user terminal 10, and verify or manage the issued electronic identification card when the user terminal 10 uses the electronic identification card.

Therefore, the present embodiment may provide a MyData service that allows a user to have control over personal information using the user terminal 10 and use an electronic identification card to prove that the user belongs to an affiliated organization, while encrypting the user information and using the user information, as necessary.

The system 100 for providing a blockchain-based MyData card of the present embodiment may allow a user to use and manage an electronic identification card through a decentralized web form of Web 3.0.

Here, Web 3.0 is a web operation model in which data is shared by service participants using decentralized technology such as blockchain, and a decentralized web form that is owned and protected by individuals while users are not dependent on a platform for data, personal information, and the like, allowing the users to manage their data with their own control.

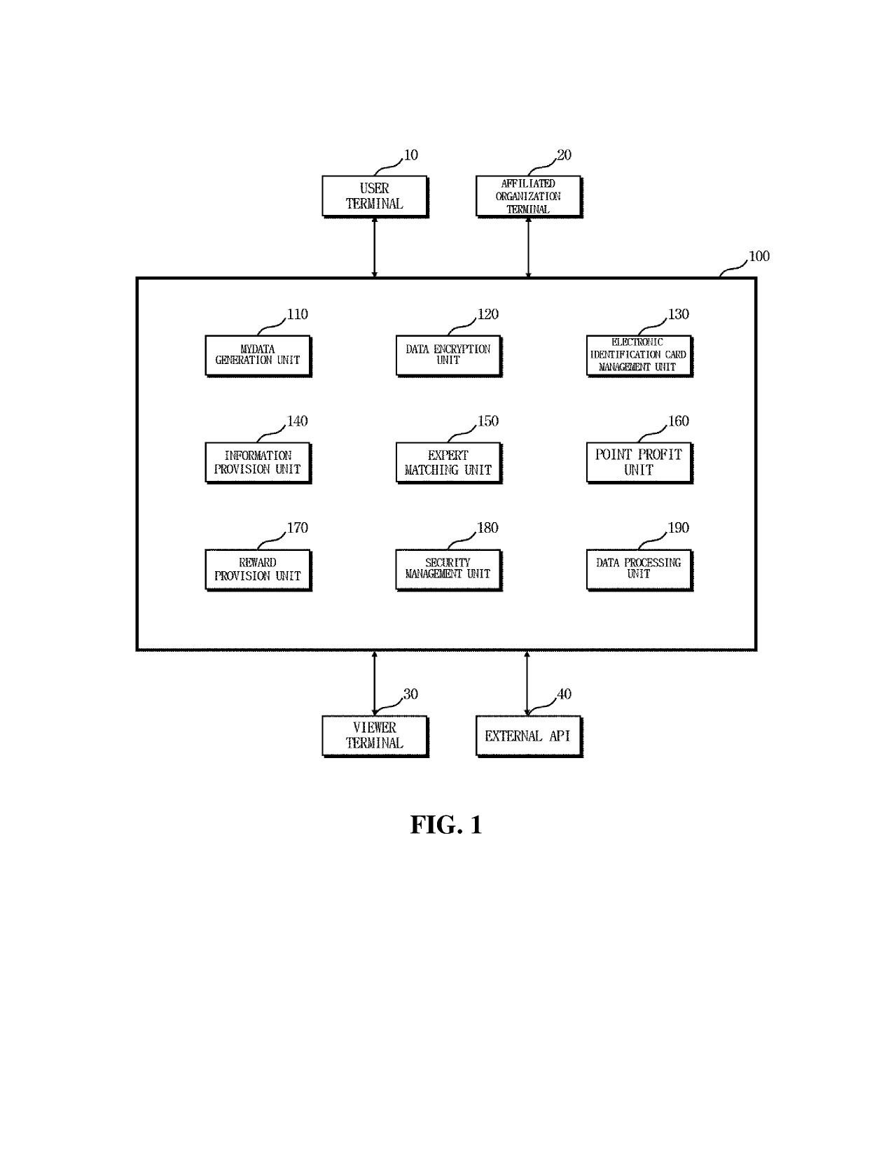

Hereinafter, each configuration of the system 100 for providing a blockchain-based MyData card according to the present embodiment will be more specifically described with reference to FIGS. 1 to 11.

First, FIG. 1 is a block diagram illustrating the system 100 for providing a blockchain-based MyData card according to the present embodiment. The system for providing a blockchain-based MyData card according to the present embodiment may include the MyData generation unit 110, the data encryption unit 120, the electronic identification card management unit 130, the information provision unit 140, an expert matching unit 150, a point profit unit 160, a reward provision unit 170, a security management unit 180, and a data processing unit 190. The system 100 may manage MyData, and issue and verify an electronic identification card in communication with the user terminal 10, the affiliated organization terminal 20, the viewer terminal 30, and the external API 40.

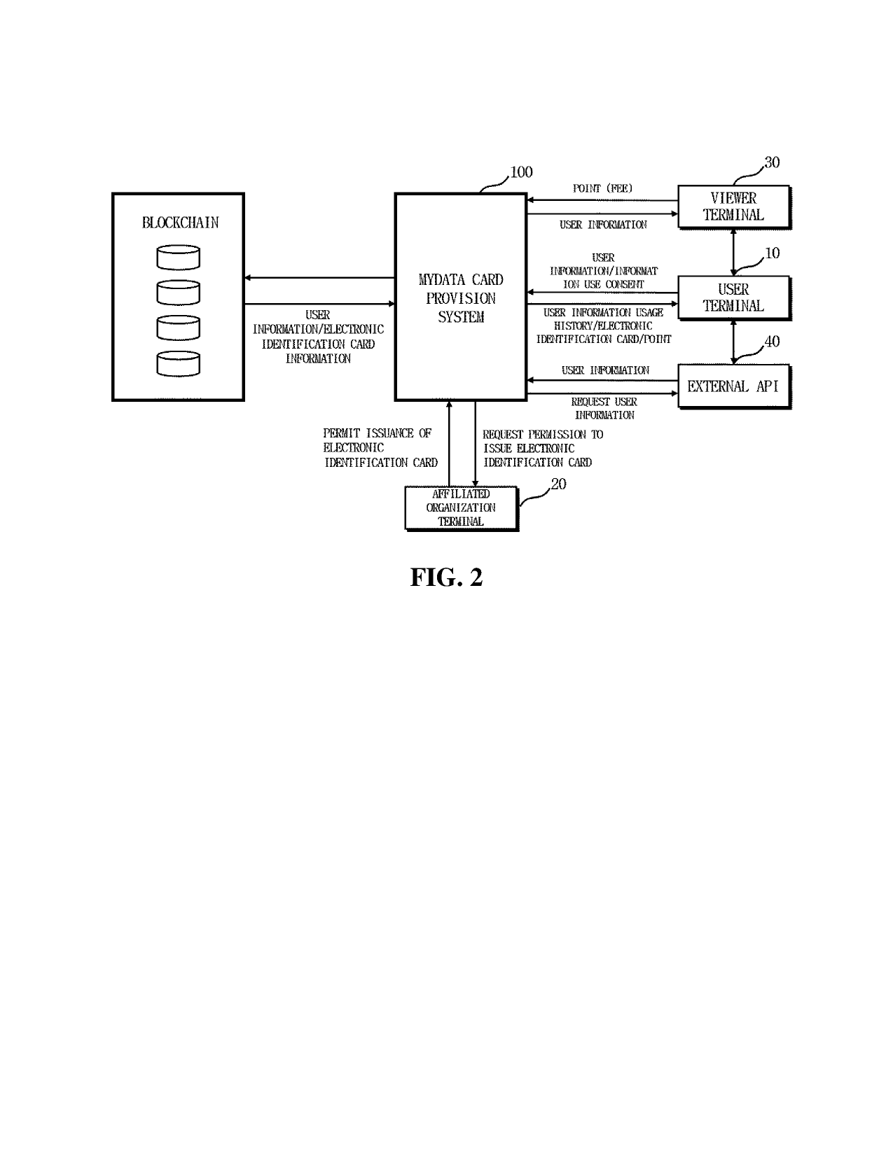

FIG. 2 is a flowchart illustrating a method of issuing an electronic identification card and providing user information according to the system 100 for providing a blockchain-based MyData card of the present embodiment, and illustrates a flow in which the system 100 according to the present embodiment communicates with the user terminal 10, the affiliated organization terminal 20, the viewer terminal 30, and the external API 40, and decentralizes and encrypts data through blockchain.

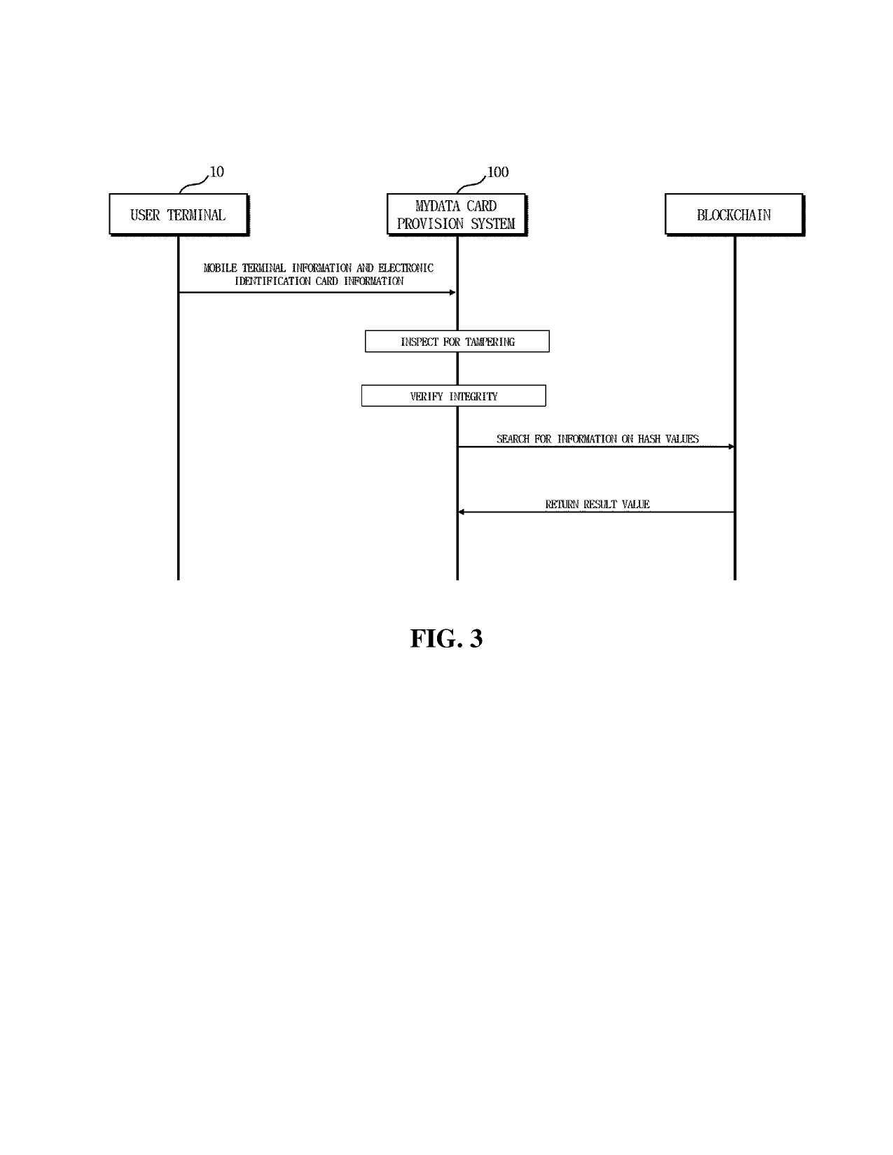

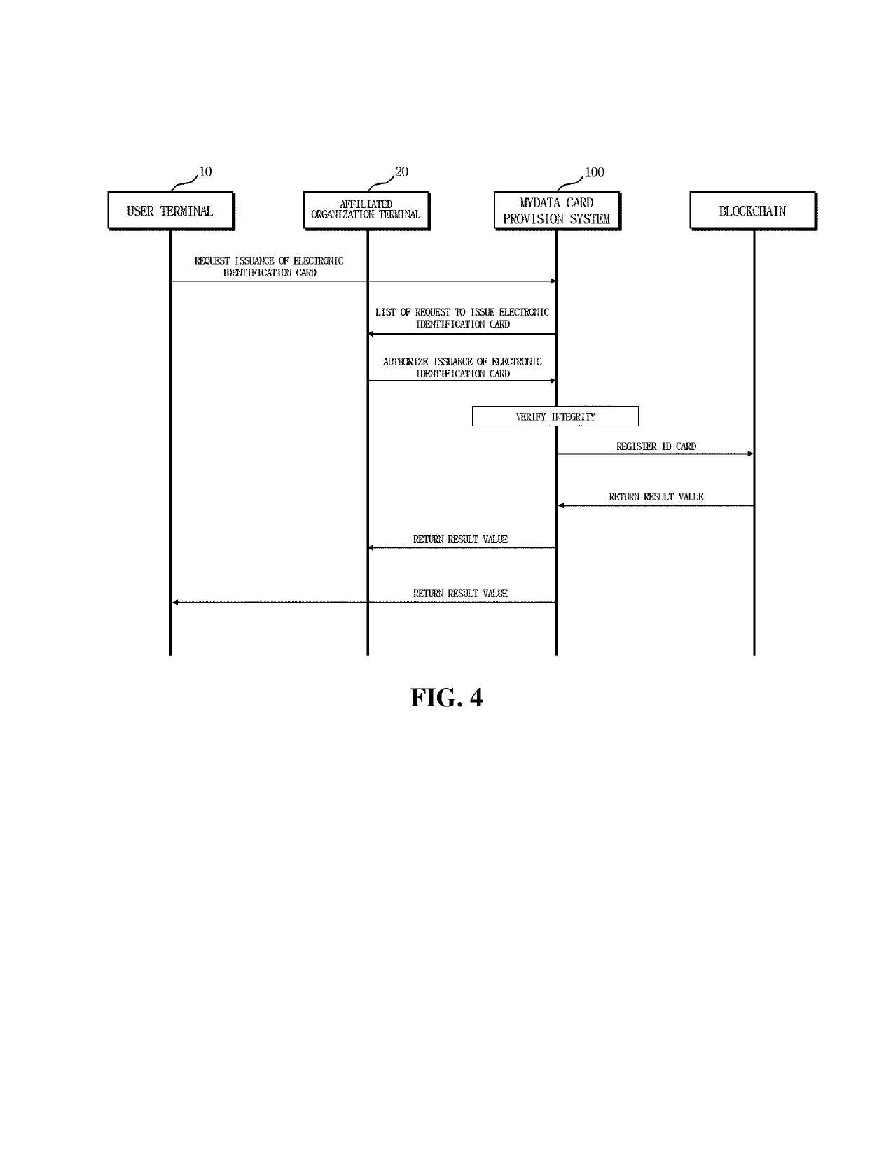

FIGS. 3 and 4 are flowcharts illustrating a method of verifying an electronic identification card and a method of issuing an electronic identification card, respectively, according to the present embodiment.

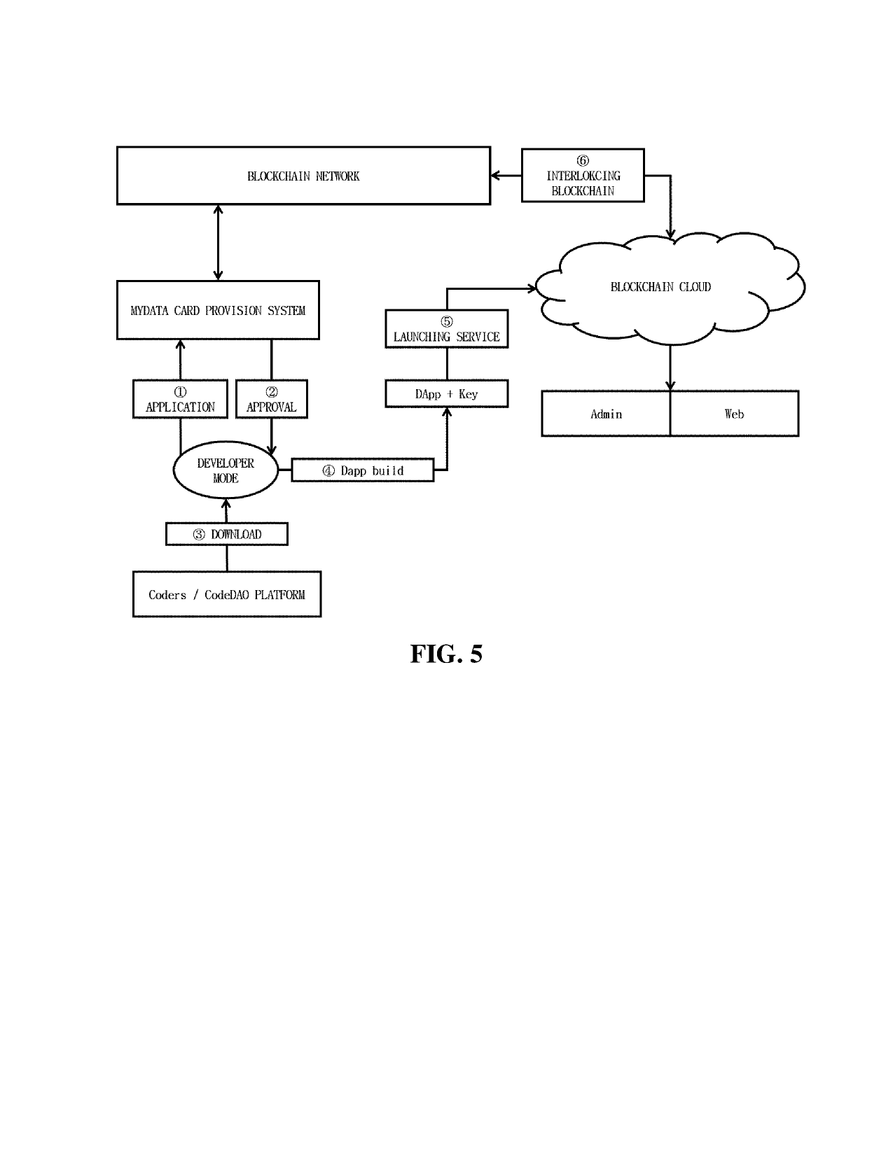

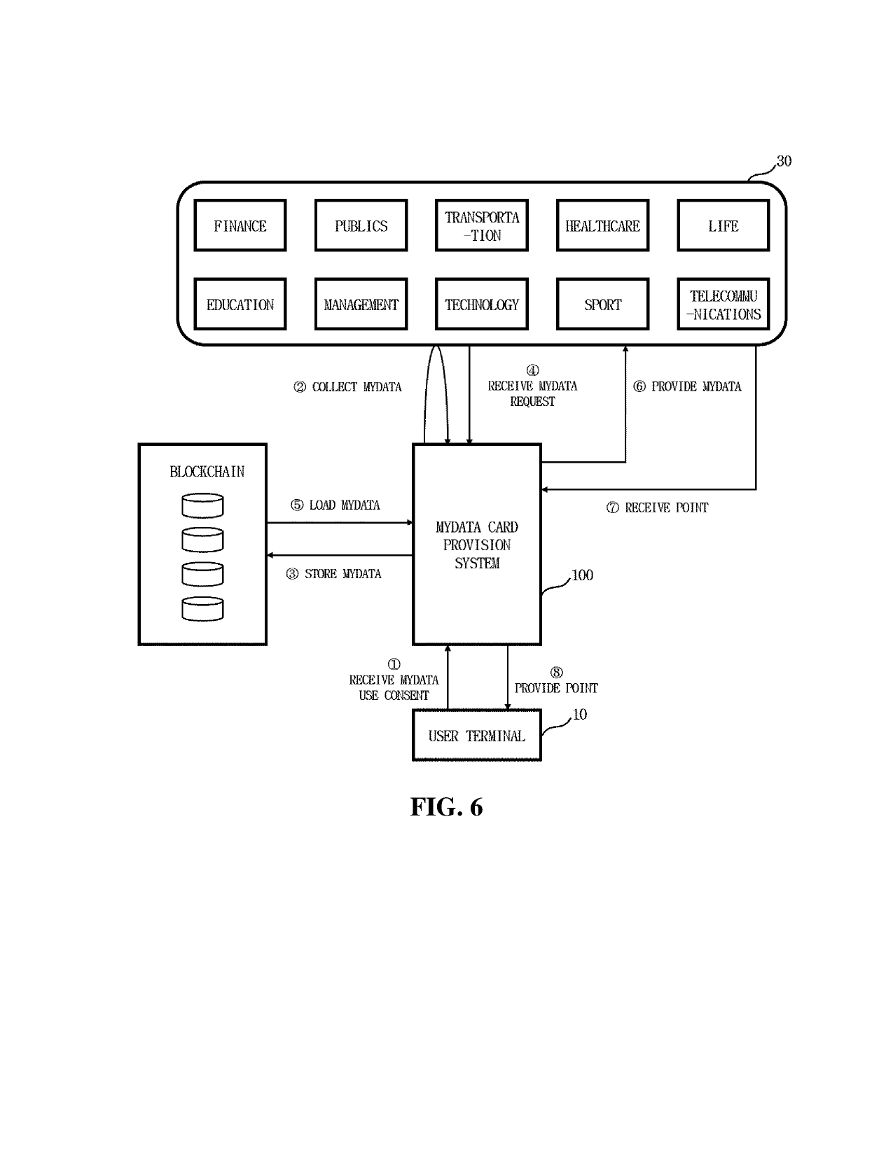

FIGS. 5 and 6 are flowcharts illustrating a method of providing a service of the system 100 for providing a blockchain-based MyData card, according to the present embodiment.

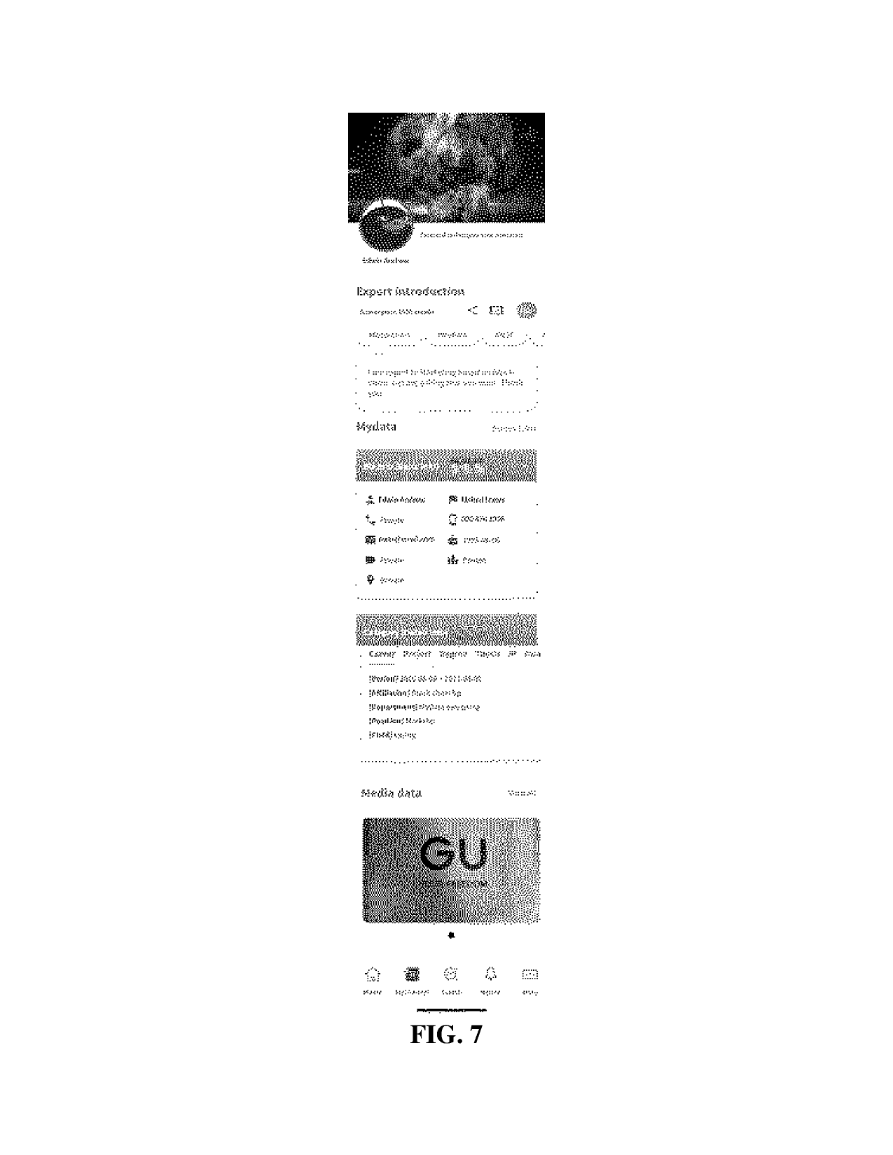

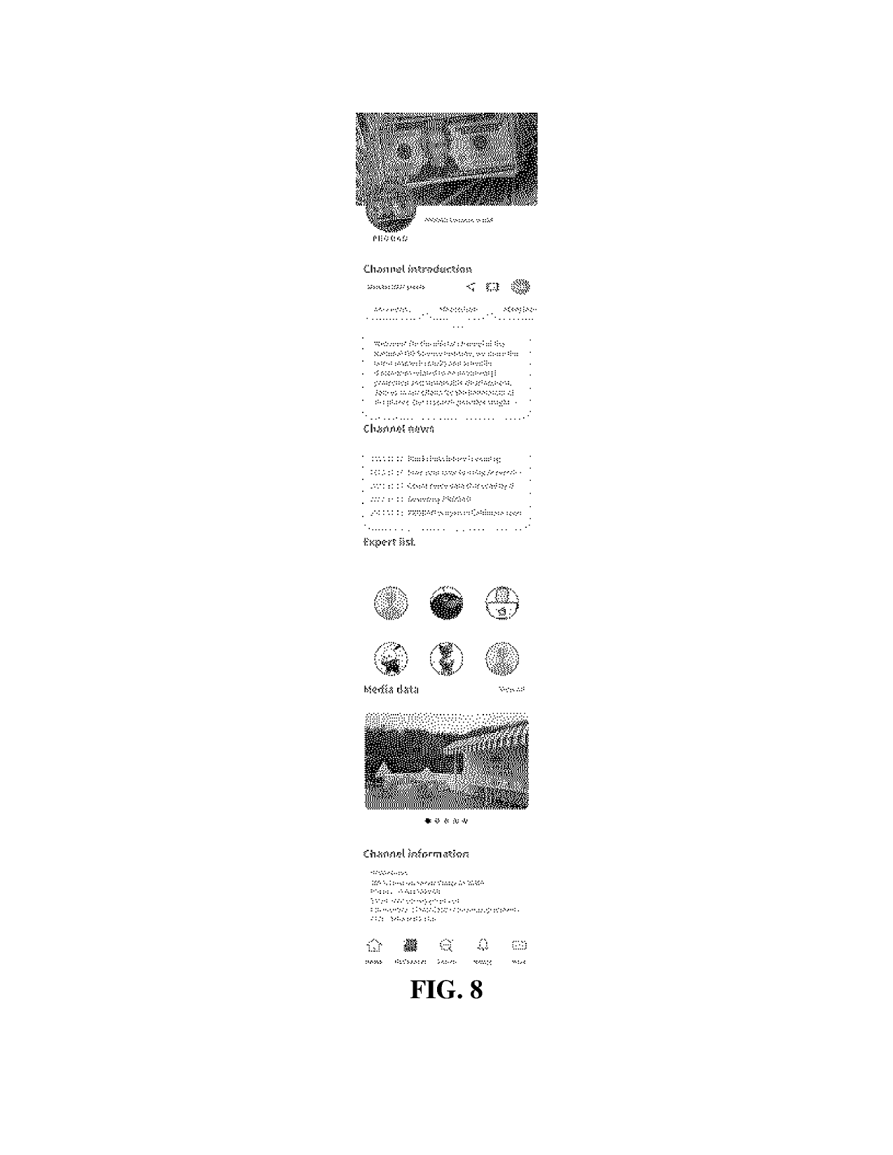

FIG. 7 is a view illustrating a user information page displaying MyData that the system 100 according to the present embodiment generates on the basis of user information provided by the user terminal 10 and the external API 40, and FIG. 8 is a view illustrating an affiliated organization information page on which the affiliated organization terminal 20 of the present embodiment represents information on an affiliated organization.

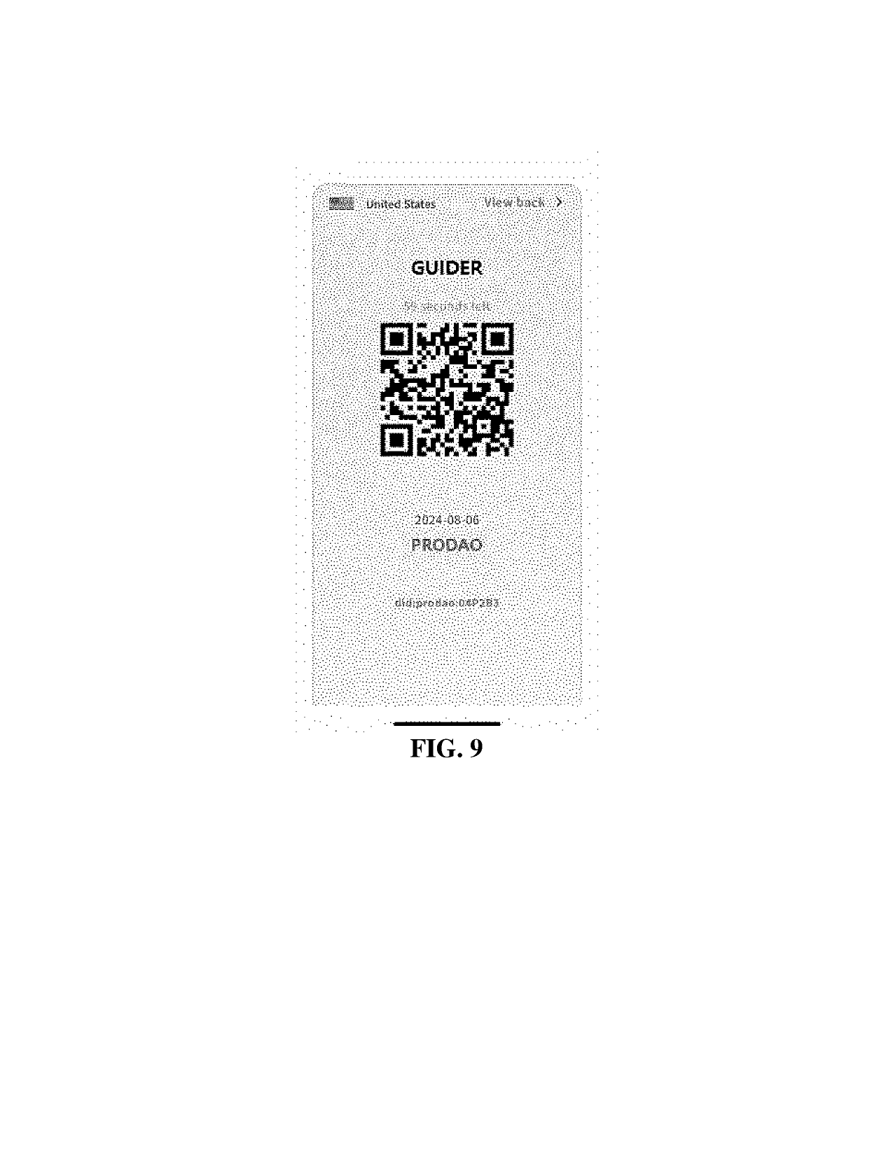

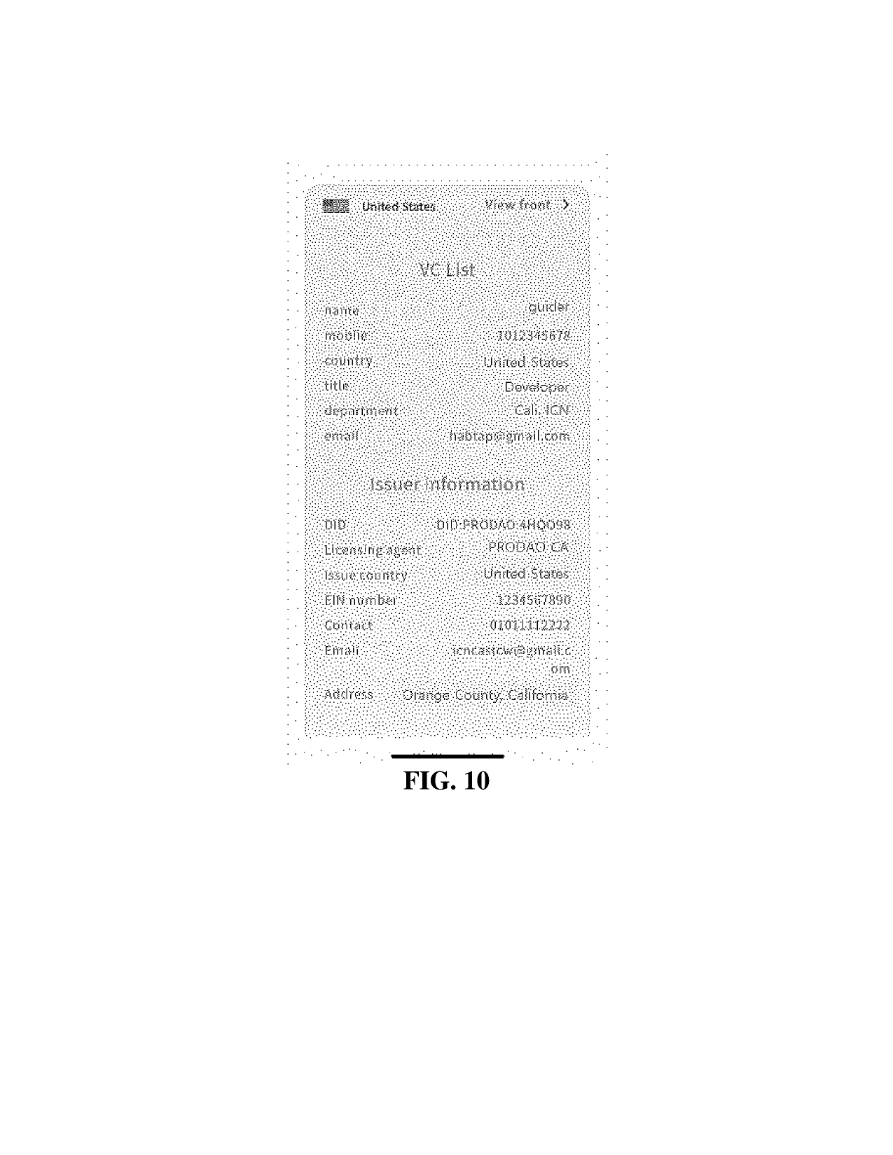

In addition, FIGS. 9 and 10 are views illustrating an electronic identification card that the system 100 according to the present embodiment issues to a user terminal 10. More specifically, FIG. 9 is a screen illustrating an electronic identification card that the user terminal 10 has been issued, showing nationality and name of a user, QR code, an expiration date of the QR code, an issue date, an affiliated organization name, and a DID address, and FIG. 10 is a screen illustrating detailed information on an electronic identification card, showing an issue number, an address, a date of birth, and an affiliated organization number (e.g., a staff number or a student number) of a user, a remarks field, a business number of the affiliated organization, and a contact information of an officer in charge of identity verification.

The user terminal 10, affiliated organization terminal 20, and viewer terminal 30 used in the present embodiment may each include a PC, a smartphone, a tablet PC, or the like capable of transmitting and receiving data using wired/wireless communication, and may also transmit and receive data using an application provided by the system 100 according to the present embodiment.

Here, the user terminal 10 is a terminal used by a user who is the subject of the user information, the affiliated organization terminal 20 is a terminal used by an affiliated organization to which the user belongs, and the viewer terminal 30 is a terminal used by a person who needs to obtain MyData including user information on a user or a person who needs to identify the validity of an electronic identification card that the user terminal 10 has been issued.

As illustrated in FIG. 1, the MyData generation unit 110 receives user information including personal basic information and personal detailed information of a user from the user terminal 10, and receives information use consent from the user terminal 10 to generate MyData by receiving the user’s information through the external API 40.

MyData enables a user to manage and control over personal information and make decisions regarding usage destination, usage scope, etc. and may include expert information including a user's career, specialty, degree, and research history, as in the present embodiment, as well as fields such as finance, healthcare, and telecommunications.

The system 100 according to the present embodiment is configured to collect and encrypt this expert information and provide the decrypted expert information to the viewer terminal 30 by receiving the consent of the user terminal 10.

More specifically, the MyData generation unit 110 may obtain user information including personal basic information and personal detailed information directly input by the user terminal 10 to generate MyData, and may also generate MyData including the user’s information provided through an API by receiving information use consent from the user terminal 10.

For example, the personal basic information described above may include a user's name, date of birth, gender, nationality, contact information, and the like. The personal detailed information described above may include a career, specialty, degree, and research history of the expert information described above. In addition, the personal detailed information may include media data and specialized keywords that may represent the user.

Furthermore, in the present embodiment, MyData may add items (categories) of personal basic information and personal detailed information according to the designation of the user terminal 10. The format of information to be input may be text, image, or the like depending on the categories added by the user terminal 10, and keywords for the information to be additionally input may also be additionally input.

For example, the user terminal 10 may add an intellectual property right item to the personal detailed information to input an intellectual property right filed by a user, and the MyData generation unit 110 may include the additional data input by the user terminal 10 to generate MyData.

In addition, as illustrated in FIG. 7, the system 100 according to the present embodiment may provide a user information page through an application installed on the user terminal 10, in which MyData of a user may be displayed.

As illustrated in FIG. 1, the data encryption unit 120 may decentralize and encrypt the MyData generated by the MyData generation unit 110 on blockchain. In other words, the data encryption unit 120 may decentralize MyData into blocks and decentralize and encrypt them on blockchain using a hash value, respectively. This enables MyData including user information to be more securely protected.

As illustrated in FIG. 1, the electronic identification card management unit 130 may issue an electronic identification card to the user terminal 10 that verifies that the user terminal 10 belongs to an affiliated organization using a blockchain-based decentralized identifier upon receiving the consent of the affiliated organization terminal 20 in response to a request from the user terminal 10, and may manage the electronic identification card issued to the user terminal 10.

In the present embodiment, the user terminal 10 needs to request an issuance of an electronic identification card from the electronic identification card management unit 130 of the present embodiment in order to get the electronic identification card issued that is capable of verifying that the user terminal 10 belongs to an affiliated organization using a blockchain-based decentralized identifier, and the electronic identification card management unit 130 may issue the electronic identification card by receiving the consent of the affiliated organization terminal 20 (see FIG. 2).

As illustrated in FIG. 3, the electronic identification card issued to the user terminal 10 may be displayed using an application provided in the present embodiment to verify the identity offline. As illustrated in FIG. 9, a user may also prove his or her identity by providing an organization to be verified, for example, a verifiable credential (VC) to the viewer terminal 30 as a verifiable presentation (VP), using a QR code through the electronic identification card management unit 130 of the present embodiment, among a signature algorithm and a plurality of “verifiable credentials (VCs)” according to the user's selection, and verifying the decentralized identifier through blockchain.

As illustrated in FIG. 1, the data processing unit 190 may collect history data that the electronic identification card management unit 130 has issued, verified, or managed an electronic identification card using blockchain, analyze and process the history data, and provide the history data to the user terminal 10 or the affiliated organization terminal 20.

More specifically, the data processing unit 190 may collect history data that an electronic identification card has been issued, verified, or managed between each of the user terminal 10, the affiliated organization terminal 20, the viewer terminal 30, and the electronic identification card management unit 130, store and track the history data using blockchain, and analyze and process the accumulated history data. The data processing unit 190 may provide the processed data described above to the user terminal 10 or the affiliated organization terminal 20 in response to a request from the user terminal 10 or the affiliated organization terminal 20.

For example, the data processing unit 190 may collect history data on markets or places where the user terminal 10 uses an electronic identification card, analyze and process the history data to derive trends based on the data, and use the derived information to provide information on fields of user preference. Furthermore, the system 100 according to the present embodiment may obtain consent from the user terminal 10 to provide the processed data to various affiliated organization terminals 20 or viewer terminals 30, allowing each affiliated organization or viewer to advertise services they provide to the user terminal 10.

In addition, the history data here may include data on the issuance, verification, or management of the electronic identification card for a plurality of affiliated organizations to which the user terminal 10 belongs, for example, the history data may include a history of the user using the electronic identification card for each of a public organization, a school, a bank, and the like.

In addition, the electronic identification card management unit 130 may also manage an electronic identification card in response to a request from the security management unit 180, which will be described in detail below.

As illustrated in FIG. 1, the information provision unit 140 may receive consent from the user terminal 10 in response to a request from the viewer terminal 30, decrypt the encrypted MyData and provide the decrypted MyData to the viewer terminal 30.

More specifically, when the viewer terminal 30 searches for users through an application provided by the system 100 according to the present embodiment and selects a user and requests MyData of the corresponding user, the information provision unit 140 may receive prior or post-consent of the user terminal 10 to provide the MyData of the user to the viewer terminal 30, at which time the MyData encrypted by the data encryption unit 120 may be decrypted and provided.

Meanwhile, as illustrated in FIG. 1, the point profit unit 160 may charge points to the viewer terminal 30 that has been provided with MyData from the information provision unit 140, where virtual currency may be used directly in addition to points purchased by the viewer terminal 30 using a credit card, cash, or the like.

In addition, as illustrated in FIG. 1, the reward provision unit 170 may provide a reward to the user terminal 10 of the user whose MyData is viewed when the viewer terminal 30 views the MyData of the user. Furthermore, the reward provision unit 170 may provide a reward to the affiliated organization terminal 20 of the affiliated organization to which the user whose MyData is viewed by the viewer terminal 30 belongs.

As illustrated in FIG. 1, the expert matching unit 150 may compare and analyze the expert information selected by the viewer terminal 30 for viewing information and the expert information input by the user terminal 10 to provide a list of recommended experts available for viewing in a descending order of similarity. For example, when the viewer terminal 30 selects a plurality of specialized keywords as expert information, a user who has input the corresponding specialized keywords may be included in a list of recommended experts, and the viewer terminal 30 may additionally select the number of publications, the number of intellectual property right registrations, and the like. Accordingly, the expert matching unit 150 may list up users matching the conditions in a descending order of similarity and provide a list of recommended experts to the viewer terminal 30.

In addition, the expert matching unit 150 may provide a list of additional experts including other users belonging to the affiliated organization of the user whose MyData was viewed on the basis of a history of viewing MyData by the viewer terminal 30, where the history of viewing MyData by the viewer terminal 30 may include the affiliated organization of the user whose MyData was viewed, a specialty, and the like.

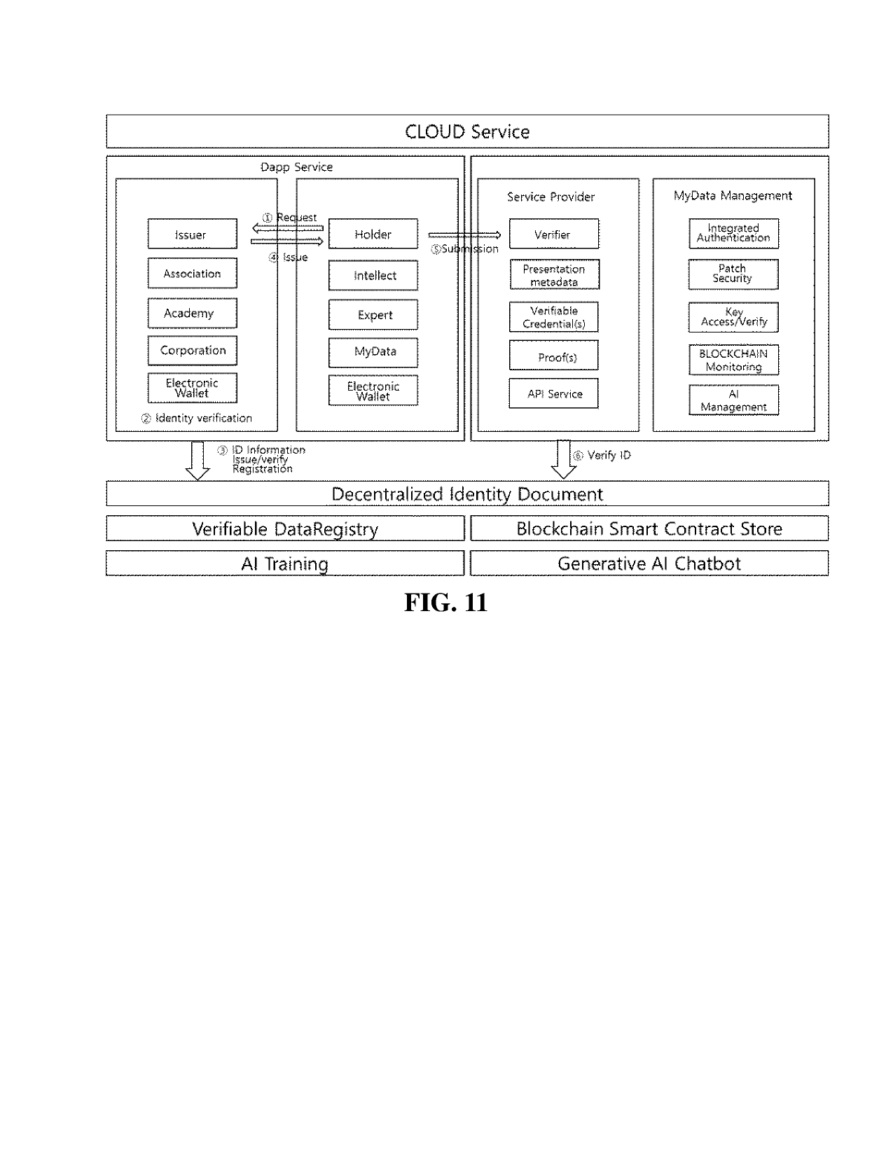

As illustrated in FIG. 11, the system 100 according to the present embodiment may provide an on-device chatbot function, in which the chatbot function may perform an analysis with an expert's MyData as base data in response to a request from the viewer terminal 30, and provide analysis result data to the viewer to guide an expert that the viewer needs.

This on-device chatbot function may provide an expert's information or the like to the viewer terminal 30 only when the expert's MyData is in an authenticated state through a personal authentication procedure or the like to be described below, and an operation process of this chatbot function may increase the reliability of the information provided by the system 100 according the present embodiment, thereby increasing the satisfaction of the viewer.

Meanwhile, as illustrated in FIG. 8, an affiliated organization information page may be generated on the basis of data input by the affiliated organization terminal 20 using an application provided by the system 100 according to the present embodiment or recorded when the user terminal 10 requests consent from the affiliated organization terminal 20 to issue an electronic identification card, and the viewer terminal 30 may identify a list of experts belonging to an affiliated organization on this affiliated organization information page.

As described above, when the viewer terminal 30 selects a user from a list of recommended experts provided by the expert matching unit 150 to view MyData, the point profit unit 160 described above may charge points by applying a discount, and the system 100 according to the present embodiment may thereby induce the use of the list of recommended experts, and may later receive an advertising request from the user terminal 10 or the affiliated organization terminal 20 to add the user or the affiliated organization that requested the advertisement to the list of recommended experts to increase the profit.

In addition, the reward provision unit 170 may differentially pay rewards to the affiliated organization terminal 20 on the basis of the number of users belonging to the affiliated organization and a consent rate for viewing information of the users belonging to the affiliated organization. The expert matching unit 150 may also assign additional points on the basis of the number of users belonging to the affiliated organization and a consent rate for viewing information of the users belonging to the affiliated organization to expose the users belonging to the affiliated organization to the top of a list of recommended experts.

It is also possible to provide an advantage according to the number of users belonging to the affiliated organization and the consent rate for viewing information of the users belonging to the affiliated organization, as described above, to induce the use of the system 100 for providing a blockchain-based MyData card of the present embodiment.

As illustrated in FIG. 1, the security management unit 180 may determine that hacking has occurred and deactivate an electronic identification card by receiving GPS information from the user terminal 10 when a request for verification of the electronic identification card is received from a remote location within a preset period of time.

As described above, when the electronic identification card is deactivated by the security management unit 180, the electronic identification card management unit 130 may notify the user terminal 10 and the affiliated organization terminal 20 of state information.

Meanwhile, the security management unit 180 may perform further personal authentication procedures from the user terminal 10 to activate the electronic identification card upon completion of the personal authentication. More specifically, when determining that hacking has occurred and deactivating the electronic identification card, the security management unit 180 may request for the personal authentication from the user terminal 10. In this regard, when the user himself or herself performs personal authentication using a separate authentication procedure such as mobile phone authentication or joint certificate authentication using the user terminal 10, the security management unit 180 may reactivate the deactivated electronic identification card.

Meanwhile, the information provision unit 140 and the expert matching unit 150 may withhold the provision of a user's MyData even at the request of a viewer when the user's electronic identification card is deactivated, and may not allow the user to be exposed in a search list and a list of recommended experts, and may allow the user's information to be exposed again when the electronic identification card is activated through the personal authentication procedure described above. Here, the reward provision unit 170 may pay a compensation reward in addition to a basic reward for viewing the user's MyData for a period corresponding to the deactivation period of the electronic identification card to compensate for the disadvantage received by the user terminal 10 and the affiliated organization terminal 20 due to the deactivation of the electronic identification card.

In addition, when viewing of the MyData of the user terminal 10 is made within a predetermined period of time before or after an occasion on which the user terminal 10 is determined to have been hacked, the security management unit 180 may recall the viewed MyData, which may prevent incorrect information from being transmitted in case that the MyData is changed by the hacking.

Meanwhile, as illustrated in FIG. 5, in a service method of the system 100 for providing a blockchain-based MyData card, a developer may apply for authentication through an electronic identity authentication platform of the present embodiment, and be issued with an encryption key and a blockchain smart contract address. Subsequently, the developer may be provided with various tools and templates through coders or DodeDAO platform to build a Dapp (decentralized operation), and provide users with a service that operates based on a blockchain network through the encryption key and Dapp described above. Here, the system 100 according to the present embodiment may provide a service for providing a blockchain-based MyData card by interlocking a blockchain cloud with a blockchain network. In addition, an administrator may manage blockchain transaction records and various requests from users (members) through Admin, and a user may be accessed through Web to request and receive services provided by the system 100 according to the present embodiment.

The system 100 according to the present embodiment, as described above, may safely manage user information and electronic identification cards with confidentiality, integrity, and availability applied on the basis of blockchain, develop applications without coding with tools and templates provided through the coders or the DodeDAO platform, and implement serverless computing using the cloud.

As illustrated in FIG. 6, the system 100 according to the present embodiment may receive consent for the use of MyData from the user terminal 10 to collect MyData of a user from each organization such as financial, public, transportation, healthcare, life, education, management, technology, sports, and telecommunication organizations, and may store the MyData using blockchain.

In addition, the viewer terminal 30, which includes financial, public, transportation, medical, life, education, management, technology, sports, telecommunications fields, and the like, may request the MyData of the user from the system 100 according to the present embodiment, and the system 100 according to the present embodiment may load the MyData from blockchain, provide the MyData to the viewer terminal 30, and receive points. As described above, a portion of the points that the system 100 according to the present embodiment receives upon providing the MyData of the user to the viewer terminal 30 may be provided to the user terminal 10 so that the user may receive a reward.

Here, the points may include cryptocurrencies and virtual currencies such as Bitcoin, Ethereum, and Ripple, as well as separate points provided by the system 100 according to the present embodiment.

As described above, when the system 100 according to the present embodiment collects the MyData of the user from various organizations, such as finance, publics, transportation, healthcare, life, education, management, technology, sports, and telecommunication, it is possible to provide necessary information to the user in addition to the previously used fields and provide more rewards for the use of MyData by using the MyData collected from various fields in various different types of fields.

In addition, the above-described technical content may be implemented in the form of program instructions executable by various computer means and thus recorded on a computer-readable medium. The computer-readable medium may include program instructions, data files, data structures, or the like, in a stand-alone form or in a combination thereof. The program instructions recorded in the medium may be specially designed and configured for the embodiments or may be known and available to those skilled in computer software. Examples of the computer-readable recording medium may include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Examples of the program instructions may include programming language codes made by, for example, a compiler, as well as high-language codes that may be executed by a computer, by using an interpreter. The hardware devices may be configured to operate as one or more software modules in order to perform the operation of the embodiments, and the opposite is also possible.

While the exemplary embodiments of the present invention have been described above, those skilled in the art may variously modify and change the present invention by adding, changing, deleting or modifying constituent elements without departing from the spirit of the present invention disclosed in the claims, and the modification and change also belong to the scope of the present invention.

### Description of Reference Numerals

10: User terminal

20: Affiliated organization terminal

30: Viewer terminal

40: External API

100: System for providing a blockchain-based MyData card

110: MyData generation unit

120: Data encryption unit

130: Electronic identification card management unit

140: Information provision unit

150: Expert matching unit

160: Point profit unit

170: Reward provision unit

180: Security management unit

190: Data processing unit

What is claimed is:

1. A system for providing a blockchain-based MyData card, the system comprising:
a MyData generation unit configured to receive user information including personal basic information and personal detailed information of a user from a user terminal, receive information use consent from the user terminal, and generate MyData by receiving the user’s information through an external API;
a data encryption unit configured to decentralize and encrypt the MyData on blockchain;
an electronic identification card management unit configured to issue an electronic identification card that proves that the user belongs to an affiliated organization to the user terminal using a blockchain-based decentralized identifier by receiving consent from an affiliated organization terminal in response to a request from the user terminal, and manage the electronic identification card issued to the user terminal; and
an information provision unit configured to decrypt and provide the encrypted MyData to a viewer terminal with consent of the user terminal in response to a request from the viewer terminal.

2. The system of claim 1, wherein the MyData includes expert information including the user's career, specialty, degree, and research history, and further comprising:
an expert matching unit configured to provide a list of recommended experts available for viewing in a descending order of similarity by comparing and analyzing the expert information selected by the viewer terminal for viewing information and the expert information input by the user terminal.

3. The system of claim 2, wherein the expert matching unit provides a list of additional experts including other users belonging to an affiliated organization of the user whose MyData is viewed on the basis of a history of viewing the MyData by the viewer terminal.

4. The system of claim 1, further comprising:
a point profit unit configured to charge points to the viewer terminal that receives the MyData from the information provision unit.

5. The system of claim 1, further comprising:
a reward provision unit configured to provide a reward to the user terminal of the user whose MyData is viewed, or to the affiliated organization terminal of an affiliated organization to which the user whose MyData is viewed belongs, when the viewer terminal views the MyData of the user.

6. The system of claim 5, wherein the reward provision unit differentially pays rewards to the affiliated organization terminal on the basis of the number of users belonging to the affiliated organization and a consent rate for viewing information of the users belonging to the affiliated organization.

7. The system of claim 1, further comprising:
a security management unit configured to determine that hacking has occurred and deactivate the electronic identification card when a request for verification of the electronic identification card is received from a remote location within a predetermined period of time by receiving GPS information from the user terminal.

8. The system of claim 7, wherein the security management unit performs an additional personal authentication procedure from the user terminal to activate the electronic identification card upon completion of the personal authentication.

9. The system of claim 7, wherein, when viewing of the MyData of the user terminal is made within a predetermined period of time before or after an occasion when the user terminal is determined to have been hacked, the security management unit recalls the MyData that has been viewed.

10. The system of claim 1, further comprising:
a data processing unit configured to collect history data that the electronic identification card management unit has issued, verified, or managed the electronic identification card using blockchain, and analyze and process the history data and provide the history data to the user terminal or the affiliated organization terminal.
